(19) United States
(12) Patent Application Publication
(10) Pub. No.: US 2010/0086778 A1
(43) Pub. Date: Apr. 8, 2010

(54) Multilayer adhesive tape

(75) Inventors: Muzaffer Fidan, Hickory, NC (US); Nilufer Tanrikulu, Denver, NC (US)

Correspondence Address: K&L Gates LLP, 214 N. TRYON STREET, HEARST TOWER, 47TH FLOOR, CHARLOTTE, NC, 28202, US

(73) Assignee: Shurtape Technologies, Inc., Hickory, NC (US)

(21) Appl. No.: 12/287,353

(22) Filed: Oct. 8, 2008

(51) Int. Cl. B32B 7/12; B05D 5/10

(52) U.S. Cl. 428/352; 428/343; 427/208.8

(57) ABSTRACT

A multilayer adhesive tape comprising a substrate and at least two layers of a pressure sensitive adhesive applied to the substrate. The at least two layers of adhesive comprise an underlayer of adhesive applied to the substrate and an overlayer of adhesive applied over the underlayer. The underlayer of adhesive has a relatively lower flowability than the overlayer of adhesive and overlayer of adhesive has a relatively greater tackiness than the underlayer of adhesive.

### FIELD OF THE INVENTION

The present invention relates to a multilayer adhesive tape, more particularly to a multilayer adhesive tape for use as a painter's tape.

### BACKGROUND OF THE INVENTION

Adhesive tapes are generally known to be used for both temporary and permanent bonding to a surface. Applications that require an adhesive tape to adhere to the surface yet subsequently be removed from the surface require suitable adhesives. It is particularly desirable for certain end use applications that the adhesive tape not cause any damage to the surface upon removal therefrom.

Thus, it is problematic when the adhesive from the tape flows into the surface and creates a strong bond with the surface because it affects the removability. A stronger bond requires a higher force for peeling off the tape from the surface. An example of an adhesive tape for which temporary bonding is necessary is painter's tape. Painter's tape is typically an adhesive tape that is applied as a guard to woodwork, wall surfaces, and other surfaces to mask such surfaces against undesired painting thereof. When the surface is painted sheetrock, the difficulty typically arises during the peel off of the tape. Sheetrock material quality varies and may contain various nooks and crannies in its surface at which more extensive bonding of the adhesive may occur making peel off more difficult.

Conventionally, painter's tape simply comprises a substrate to one side of which is applied a single layer of adhesive, typically, an acrylic polymer. A so-called “release” layer must be applied to the opposing non-adhesive side of the tape substrate. Ideally, such tape should provide two properties, namely a tacky adhesive feel to the human touch, commonly referred to as “wet grab,” and so-called peel adhesion, which refers to the ability to accomplish a physical bond to a surface to which applied. These two properties are difficult to balance using a single layer of a given adhesive due to adhesion buildup over time.

Furthermore, conventional acrylic polymer adhesive is known to flow, whereby the physical bond created by the adhesive becomes stronger with the elapsed time the adhesive tape is left applied to a given surface. This quality can be detrimental in a painter's tape in that, if the tape is left on a surface too long, the adhesive will tend to flow more and more progressively over time such that the adhesive bond can potentially strengthen to the point of causing damage to the underlying surface when removed. With a conventional acrylic polymer, a softer adhesive formulation provides a desirable wet grab quality but produces a higher than desirable polymer flow which, over time, creates too strong a peel adhesion. However, if an acrylic polymer is formulated to have a harder consistency, then the amount of polymer flow can be reduced thereby controlling the peel adhesion, but the physical feel of the adhesive to the touch provides a poor level of wet grab which is undesirable to most users. Hence, it is difficult to balance the two characteristics using only a single layer of a single type of adhesive.

The present invention therefore seeks to improve upon and overcome the difficulty associated with conventional adhesive tape such as a painter's tape by imparting to such tape both wet grab and peel adhesion.

### SUMMARY OF THE INVENTION

The present invention is directed to a multilayer adhesive tape for use in temporary bonding applications that overcomes disadvantages associated with known single layer adhesive tapes used for the same purpose. The multilayer adhesive tape of the present invention comprises a substrate, and at least two layers of a pressure sensitive adhesive applied to the substrate. The at least two layers of adhesive comprise an underlayer of adhesive applied to the substrate and an overlayer of adhesive applied over the underlayer, wherein the underlayer of adhesive has a relatively lower flowability than the overlayer of adhesive and overlayer of adhesive has a relatively greater tackiness than the underlayer of adhesive.

The present invention is also directed to a multilayer adhesive tape comprising a substrate, and at least two layers of a pressure sensitive adhesive applied to the substrate. The at least two layers of a pressure sensitive adhesive comprise an underlayer of adhesive applied to the substrate and an overlayer of adhesive applied over the underlayer, wherein the adhesive of the underlayer has a higher glass transition temperature than the adhesive of the overlayer.

The present invention is also directed to the methods of making such multilayer adhesive tapes.

The present invention is also directed to a painter's tape comprised of a saturated paper having opposing sides and at least two layers of acrylic pressure sensitive adhesive applied to a first side of the saturated paper, and a release coating applied to a second side of the saturated paper. The at least two layers of acrylic pressure sensitive adhesive comprise an underlayer of acrylic pressure sensitive adhesive applied to the first side of the saturated paper and an overlayer of acrylic pressure sensitive adhesive applied over the underlayer, wherein the underlayer has a relatively lower flowability than the overlayer and overlayer has a relatively greater tackiness than the underlayer.

The present invention is also directed to a painter's tape comprised of a saturated paper having opposing sides and at least two layers of acrylic pressure sensitive adhesive applied to a first side of the saturated paper, and a release coating applied to a second side of the saturated paper. An underlayer of adhesive is applied to the substrate and an overlayer of adhesive is applied over the underlayer and the adhesive of the underlayer has a higher glass transition temperature than the adhesive of the overlayer.

The present invention is also directed to the methods of making such painter's tapes.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a graphical illustration of the data of Table 13 illustrating adhesion build-up on a painted surface in accordance with the present invention.

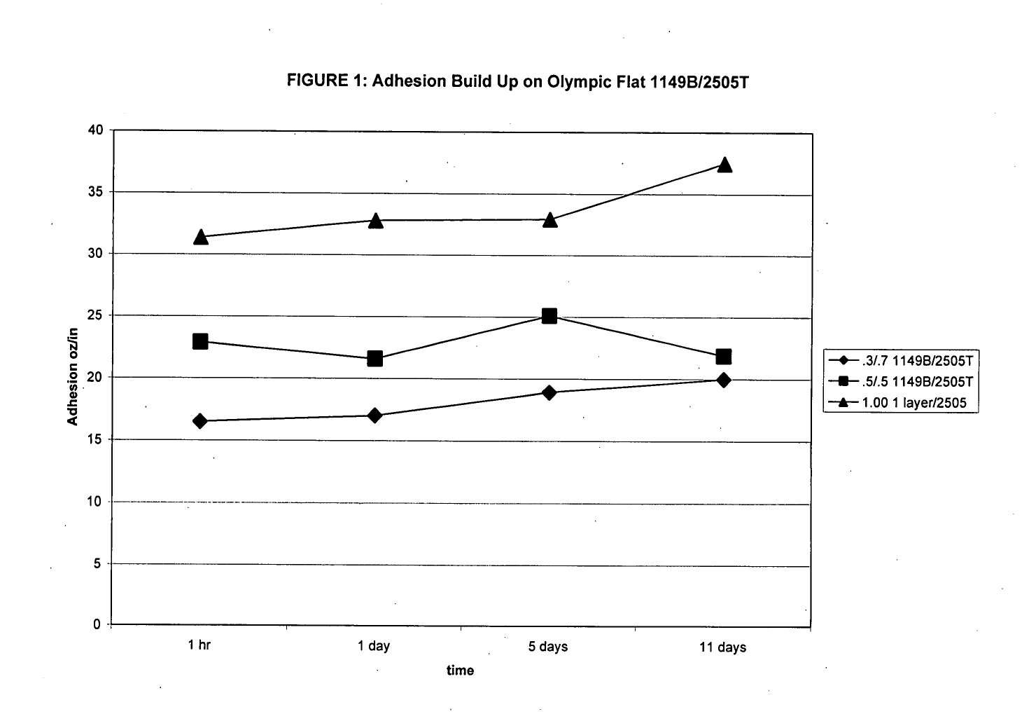

FIG. 2 is a graphical illustration of the data of Table 14 illustrating adhesion build-up on a painted surface in accordance with the present invention.

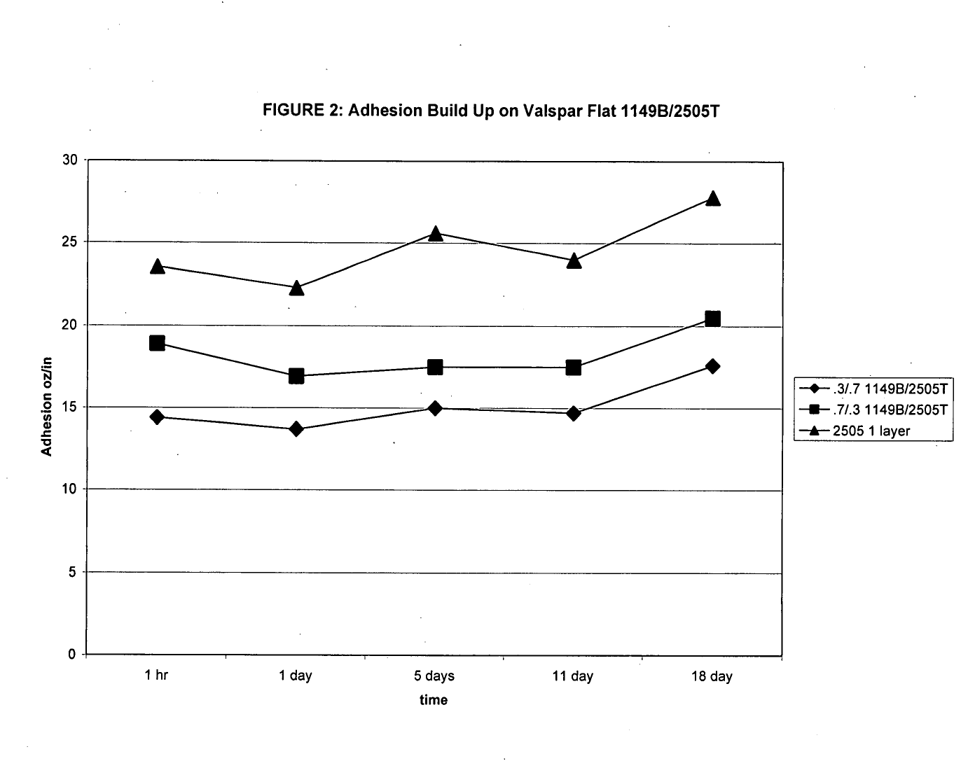

FIG. 3 is a graphical illustration of the data of Table 15 illustrating adhesion build-up on a painted surface in accordance with the present invention.

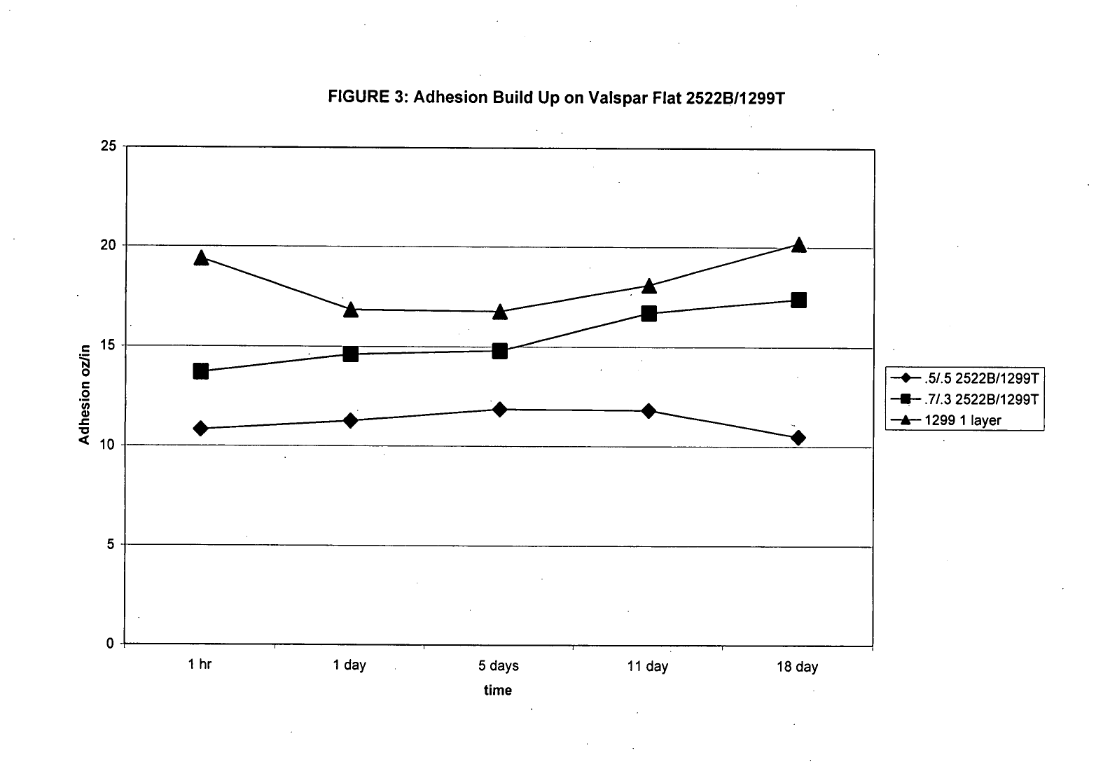

FIG. 4 is a graphical illustration of the data of Table 17 illustrating adhesion build-up on a painted surface from the Comparative Example.

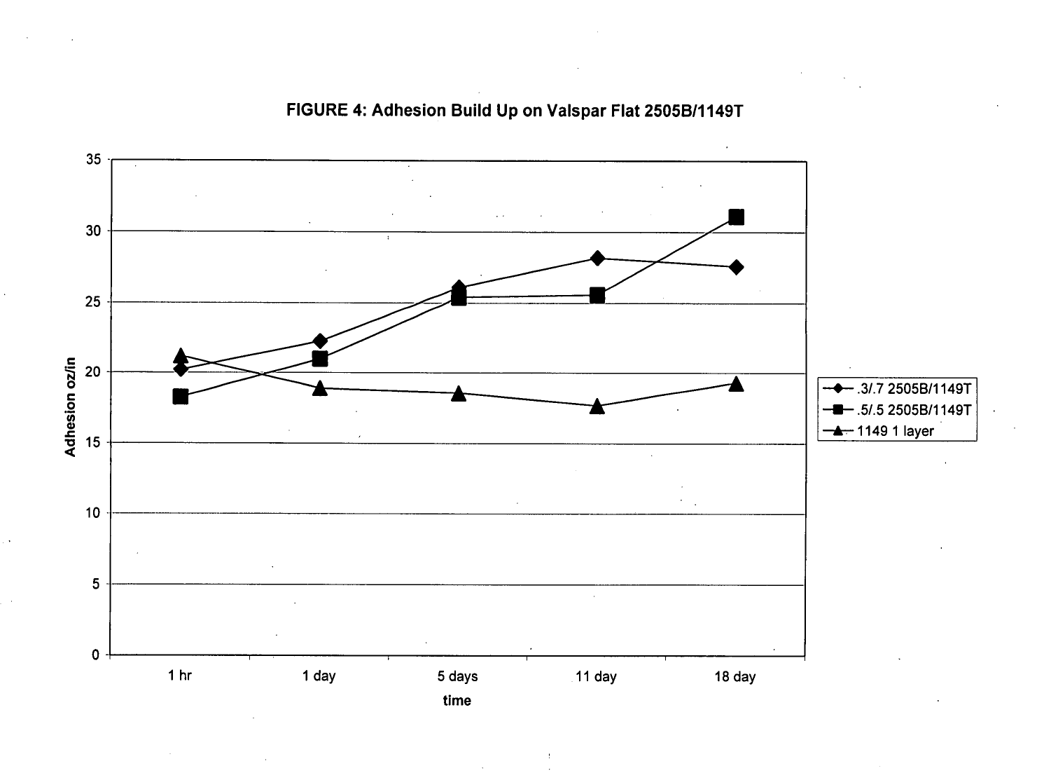

### DETAILED DESCRIPTION OF THE INVENTION

The following detailed description of the embodiment(s) is merely exemplary in nature and is in no way intended to limit the invention, its application, or uses.

The present invention seeks to improve upon a conventional adhesive tape for use in an end-use application where temporary bonding is desirable. Furthermore, the present invention seeks to overcome the difficulty of imparting to such a conventional adhesive tape both tactile feel characteristics, referred to herein as wet grab, and peel adhesion by applying multiple layers of adhesive to a tape substrate.

The multilayer adhesive tape of the present invention generally comprises a tape substrate and at least two layers of a pressure sensitive adhesive applied to the tape substrate. The at least two layers of adhesive are comprised of a bottom or underlayer of adhesive applied to the tape substrate and an overlayer of adhesive applied over the underlayer of adhesive, wherein the underlayer of adhesive layer has a relatively lower measurable flowability than the overlayer and the overlayer of adhesive has a relatively greater measurable tackiness than the bottom layer.

Materials suitable for use as the tape substrate include, but are not limited to, paper and film. Examples of papers include, but are not limited to, saturated paper, release coated paper, flat back paper, crepe paper, and kraft paper. Among representative saturants are styrene-butadiene rubber (SBR), acrylic, ethylene vinyl acetate, and polyurethane. Among representative films are polymeric films such as polyester and polypropylene including, but not limited to, oriented polypropylene (OPP), monoaxially oriented polypropylene (MOPP), and biaxially oriented polypropylene (BOPP). Release coatings suitable for use with the present invention include, but are not limited to, silicone, acrylic, fluorinated polymers, and vinyl acetate polymers.

The underlayer of adhesive is comprised of a relatively hard adhesive, with the formulation of the adhesive being such to moderate the degree of peel adhesion imparted by this layer of adhesive. The overlayer of adhesive is comprised of an adhesive that is softer than the relatively hard adhesive of the underlayer and is selected to provide a desirable level of tackiness to a user's feel. The thickness of the overlayer of adhesive is considerably thinner than a single adhesive layer commonly used in conventional painter's tape. The overlayer of adhesive is selected so as to minimize the degree to which the softer adhesive flows and thereby minimize or prevent an undesirable increase in peel adhesion over time.

An adhesive suitable for use in the multilayer adhesive tape of the present invention is a pressure sensitive adhesive. The term “pressure sensitive adhesive,” as used herein refers to, materials which in dry form are generally aggressively and permanently tacky at room temperature and firmly adhere to a variety of dissimilar surfaces upon mere contact without the need of more than typically finger or hand pressure. A pressure sensitive adhesive typically does not require activation by solvents or heat and adheres firmly to a wide variety of surfaces.

The pressure sensitive adhesive may be solvent based, water based, or in 100% solid form. Suitable types of pressure sensitive adhesives include, but are not limited to, acrylic, synthetic rubber, natural rubber, polyurethane, styrene-butadiene rubber (SBR), synthetic isoprene rubber, ethylene vinyl acetate copolymers, and silicones. Preferably, the pressure sensitive adhesive is an acrylic, more preferably a water based acrylic. Optionally, the pressure sensitive adhesive is cross-linked.

In accordance with the present invention, the glass transition temperature (Tg) is used as a measure of the relative degree of hardness or softness of the adhesive. The adhesive layers' respective softness and hardness are relative to one another. Generally, the higher the glass transition temperature, the harder the adhesive. Thus, in the context of the present invention, the underlayer of adhesive is harder than the overlayer and, thus, the underlayer of adhesive has a relatively higher glass transition temperature as compared to the overlayer of adhesive. In accordance with the present invention, it is preferred that the adhesive of the underlayer is harder as compared to the adhesive of the overlayer.

For a multilayer adhesive tape for use as a painter's tape, a harder adhesive has a lower flowability than a softer adhesive. A softer adhesive also has greater measurable tackiness as compared to a harder adhesive. A 90 degree quick stick value, for example, may be used an indication of the relative tackiness (i.e. wet grab) of one adhesive layer as compared to another. For example, a softer adhesive has a higher 90 degree quick stick value as compared to a harder adhesive. Thus, the 90 degree quick stick value may be used as a measure of the relative tackiness of an adhesive.

The layers of the multilayer adhesive tape of the present invention are present in relative thicknesses to one another. Preferably, the relative thickness of the underlayer layer as compared to the overlayer layer is in a range of from about 30:70 to 70:30, more preferably from about 40:60 to 60:40.

The multilayer adhesive tape of the present invention preferably has a peel adhesion from a painted surface, such as painted sheetrock or wallboard, in the range of from about 10 oz/inch to about 25 oz/inch, more preferably in the range of from about 15 oz/inch to 22 oz/inch. For example, in a painter's application for painting on painted or coated sheetrock, the peel adhesion is preferably below 35 oz/inch to avoid delamination of paper from gypsum. At too low a peel adhesion to a painted substrate, however, tape curls or comes off the surface.

Furthermore, the present invention also provides a method of making the multilayer adhesive tape. The method generally comprises providing a substrate and applying at least two layers of adhesive to the substrate, wherein an underlayer layer of adhesive is applied to the substrate and an overlayer layer of adhesive is applied over the underlayer. The underlayer and overlayer adhesives have the characteristics discussed above in accordance with the present invention.

The present invention is also directed to a multilayer adhesive tape for use as a painter's tape. In accordance with the present invention, the painter's tape comprises a saturated paper having opposing sides, at least two layers of acrylic pressure sensitive adhesive applied to a first surface of the saturated paper, and a release coating applied to a second side of the saturated paper, wherein an underlayer of adhesive is applied to the first side of the saturated paper and an overlayer of adhesive is applied over the underlayer. The underlayer has a relatively lower measurable flowability than the overlayer and the overlayer has a relatively greater measurable tackiness than the underlayer. Also, in accordance with the present invention, is a painter's tape comprising a substrate having opposing sides, at least two layers of an acrylic pressure sensitive adhesive applied to the substrate, wherein an underlayer of adhesive applied to the substrate and an overlayer of adhesive applied over the underlayer and the adhesive of the underlayer has a higher glass transition temperature than the adhesive of the overlayer.

Any of the substrate materials discussed previously in accordance with the multilayer adhesive tape of the present invention are contemplated as being suitable for use in a painter's tape. However, paper is particularly desirable as a substrate in a painter's tape. It is preferred that the paper is a saturated paper in a painter's tape. Any of the saturants discussed previously may be used in accordance with the present invention. Likewise, although paper is contemplated as being suitable for use as a substrate in a painter's tape, crepe paper and kraft paper are particularly desirable types of paper for use in a painter's tape.

Among the numerous advantages of the multilayer adhesive tape of the present invention is dramatically longer term usability of the multilayer adhesive tape of the present invention without undesirably damaging peel adhesion as compared to conventional adhesive tapes.

### EXAMPLES

### Example

### Glass Transition Temperature (Tg) Tests by Differential Scanning Calorimetry (DSC)

Data on glass transition temperature (Tg) by DSC was obtained for various AROSET® water based acrylic pressure sensitive adhesives from Ashland, Inc. and is set forth in Table 1. The thermal transitions of the submitted samples were measured via the TA Instruments Q2000 DSC using crimed aluminum pans. The samples were heated at 10° C./minute from −150 to 100° C. The DSC cell was purged with helium at a rate of 25 cc/minute to prevent moisture condensation during cooling. The midpoint of the glass transition temperature is identified from the temperature corresponding to the half-height of the thermal transition.

TABLE 1

| Adhesive | Tg Extrapolated Onset C. | Tg Mid Point C. |
|---|---|---|
| AROSET ® 2505 | −69.9 | −58.5 |
| AROSET ® 2505 | −70 | −58.5 |
| AROSET ® 1149-1 | −43.1 | −38.1 |
| AROSET ® 1149-1 | −43.1 | −38.2 |
| AROSET ® 2522 | −43.6 | −38.8 |
| AROSET ® 2522 | −44.6 | −38.9 |
| AROSET ® 1299 | −62.8 | −54.6 |
| AROSET ® 1299 | −62.2 | −54.2 |

### Examples

### Multilayer Adhesive Tapes

Experiments were conducted with the objective of reducing adhesive flow by preparing a multilayer adhesive tape. A harder adhesive was selected for the bottom or underlayer as compared to the top or overlayer and a softer, tackier adhesive was selected for the top layer as compared to the bottom layer. In order to achieve this type of coating, the bottom adhesive was coated with a Mayer Bar having a width of 5 inches on 8 inch wide paper so that coating was not edge to edge. A second pass adhesive coating method was selected using a comma roll. The comma roll ears were placed on non-coated section of the paper to eliminate adhesive sticking and/or jerking. The adhesive selected for the bottom layer was AROSET® 1149-1 and the top layer was AROSET® 2505. It was very soft and flowed quickly when applied on substrates.

### Example 1

### Preparation of Multilayer Adhesive Tapes

An adhesive was selected for the overlayer or top adhesive. The top adhesive was AROSET® 2505, an acrylic pressure sensitive adhesive from Ashland, Inc. An adhesive was selected for the underlayer or bottom adhesive. The bottom adhesive was AROSET® 1149-1, an acrylic pressure sensitive adhesive from Ashland, Inc.

A drawn down method was used to evaluate adhesives. According to the draw down method, an 8 inch wide backing (saturated and release coated) was obtained and adhesive was applied to the opposite side of the release coating via Mayer bar to get the desired adhesive coat weight and then the wet adhesive coated backing was dried in an oven. Draw down samples were dried at 200° F. for 1 minute and 30 seconds, then conditioned at 72° F., 60% relative humidity for twenty-four hour before testing (unless otherwise indicated).

TABLE 2

Sample

| | 1 | 2 | 3 | 4 |
|---|---|---|---|---|
| Top Adhesive Layer | 0.6 | 0.5 | 0.4 | 1.25 |
| Coating Weight (oz/yd²) | | | | |
| Bottom Adhesive Layer | 0.4 | 0.5 | 0.6 | 0 |
| Coating Weight (oz/yd²) | | | | |

Adhesion build-up on stainless steel panels was measured at 180° Peel with Q tester.

TABLE 3

| Days | Sample 1 | Sample 2 | Sample 3 | Sample 4 |
|---|---|---|---|---|
| Initial | 27.3 oz/in | 31.4 oz/in | 33.7 oz/in | 27.8 oz/in |
| 9 days | 32.2 oz/in | 32.8 oz/in | 35.7 oz/in | 24.8 oz/in |
| 14 days | 35.0 oz/in | 34.1 oz/in | 38.0 oz/in | 22.1 oz/in |

The test panels were prepared for the following test by painting wallboard. To paint the wallboard, wallboard was coated with one layer of primer. The primed layer was cured (dry) for at least 24 hours. A top layer was then applied and allowed to cure (dry) at least seven days before tape application. The prepared tape was applied and rolled down with a 4½ lb roller to the test panels. The test panels were cut into 1.5 inch×18 inch panels. The tape was pulled off at a 180 degree angle and the force per inch was measured.

Adhesion build-up on panels painted with Sherwin-Williams DURATION® paint was measured as function of time. DURATION® paint is a styrene-acrylic paint. For the test panels, wallboard was primed with Sherwin-Williams 200 prime and 2 days after painted with Sherwin-Williams DURATION® paint with roller then dried at least 7 days and cut into 1.5 inch×18 inch panels. 180 degree Peel with Q tester was measured for each of the Samples 1 to 4.

TABLE 4

| | | Sample Adhesive System | | | |
|---|---|---|---|---|---|
| | | 1 | 2 | 3 | 4 |
| Initial (instant) | | 13.4/13.5 | 16.8/14.5 | 13.5/13.3 | 26.6/29.6 |
| 1 | day | 19.3/16.6 | 16.9/17.6 | 20.1/15.4 | 42.4/50.7 |
| 9 | days | 25.2/26.5 | 21.4/19.1 | 19.9/19.5 | 66.2/69.9 |
| 14 | days | 20/26.5 | 23.7/20.2 | 21.9/20.7 | 61.0/69.7 |
| | | * | * | * | |

* denotes moderate flow as compared to Sample 4 which has 1.25 oz/yd².

Physical properties of Draw Down samples are set forth below.

TABLE 5

| | Sample | | | |
|---|---|---|---|---|
| | 1 | 2 | 3 | 4 |
| Adhesion To | 27.3 | 31.4 | 33.7 | 27.8 |
| Steel (ATS) | | | | |
| (oz/in) | | | | |
| 90° Quick Stick | 17/21.8 | 20.7/22.6 | 18.4/20.82 | 19.1/18.24 |
| (oz/in) | | | | |
| Total weight | 3.21 | 3.13 | 3.19 | 3.33 |
| (oz/yd²) | | | | |
| Backing weight | 2.09 | 2.09 | 2.09 | 2.09 |
| (oz/yd²) | | | | |
| Adhesive | 1.11 | 1.04 | 1.1 | 1.24 |
| weight (actual) | | | | |
| (oz/yd²) | | | | |
| Tape gauge | 5.3 | 5.0 | 5.1 | 5.3 |
| (mils) | | | | |
| Backing gauge | 4.4 | 4.4 | 4.3 | 4.3 |
| (mils) | | | | |

### Example 2

### AROSET® 2505 and Curing Agent

TABLE 6
Pilot Coating

| | Samples | | |
|---|---|---|---|
| | 1 | 2 | 3 |
| Top coating | AROSET ® 2505 | AROSET ® 2505 | AROSET ® |
| | | | 2505 |
| Bottom coating | AROSET ® 2505 + | AROSET ® 1149 | |
| | 1% zirconium | | |
| | amonium carbonate | | |
| Bottom coating | 0.3 oz/yd² | 0.3 oz/yd² | 0 |
| wt | | | |
| Top coating wt | 0.7 oz/yd² | 0.7 oz/yd² | 1.0 oz/yd² |

First pass pilot adhesive coating: bottom adhesive was coated via Mayer Bar coating method; there was about 2 inches dry edges from each side then:

Second pass pilot adhesive coating: top adhesive was coated via comma roll; the ears were placed onto the dry zones of the paper so that ears did not stick to the dry adhesive coated section.

TABLE 7
Physical Test Data

| | 180° | Adhesion | | | Rolling | | | | | |
|---|---|---|---|---|---|---|---|---|---|---|
| | Adhesion | To | 90° | High | Ball | | | | | |
| | To Steel | Backing | Quick | Speed | (ball size | Total | Backing | Adh. | | Backing |
| Sample | (ATS) | (ATB) | Stick | Unwind | 7/8 in) | Wts. | Wts. | Wts. | Gauge | Gauge |
| Sample 1: | | | | | | | | | | |
| 1% Zr in 2505 as | | | | | | | | | | |
| Bottom and 2505 | | | | | | | | | | |
| as Top | | | | | | | | | | |
| 2 Pass | | | | | | | | | | |
| 1 | 29 | 6 | 13 | 9 | 4.2 | 3.11 | 2.13 | 0.98 | 4.7 | 4.2 |
| | | | | | 3.8 | | | | | |
| 2 | 28 | 6 | 12 | 15 | 4.9 | 3.15 | 2.15 | 1.00 | 4.8 | 4.2 |
| | | | | | 4.2 | | | | | |
| Avg | 29 | 6 | 12.5 | 12 | 4.3 | 3.13 | 2.14 | 0.99 | 4.8 | 4.2 |
| Sample 2: | | | | | | | | | | |
| 1149 bottom & | | | | | | | | | | |
| 2505 Top | | | | | | | | | | |
| 2 Pass | | | | | | | | | | |
| 1 | 35 | 5 | 16 | 9 | 8.7 | 3.13 | 2.13 | 1.00 | 4.8 | 4.1 |
| | | | | | 4 | | | | | |
| 2 | 31 | 5 | 16 | 11 | 5.2 | 3.19 | 2.2 | 0.99 | 4.8 | 4.2 |
| | | | | | 4.3 | | | | | |
| Avg. | 33 | 5 | 16 | 10 | 5.6 | 3.16 | 2.17 | 1.00 | 4.8 | 4.2 |
| Sample 3: | | | | | | | | | | |
| 2505 Adhesive | | | | | | | | | | |
| 1 | 20 | 7 | 10 | 10 | 6.7 | 3.03 | 2.07 | 0.96 | 5.0 | 4.1 |
| | | | | | 5.5 | | | | | |
| 2 | 19 | 7 | 8 | 12 | 4.9 | 3.29 | 2.11 | 1.18 | 5.5 | 4.1 |
| | | | | | 3.8 | | | | | |
| Avg. | 19.5 | 7 | 9 | 11 | 5.2 | 3.16 | 2.09 | 1.07 | 5.3 | 4.1 |

Samples were aged 16 hrs 150 F at 60% humidity

TABLE 8

| | | Adhesion | | | |
|---|---|---|---|---|---|
| | 180° | To | 90° | High | |
| | Adhesion To | Backing | Quick | Speed | Rolling |
| Sample | Steel (ATS) | (ATB) | Stick | Unwind. | Ball |
| 1% Zr in 2505 | 31 | 10 | 10 | 41 | 4.5 |
| as Bottom and | | | | | |
| 2505 as Top | | | | | |
| 2 Pass | | | | | |
| 1149 Bottom | 28 | 9 | 10 | 33 | 5.5 |
| & 2505 Top | | | | | |
| 2 Pass | | | | | |
| 2505 | 23 | 11 | 5 | 33 | 3.8 |
| Adhesive | | | | | |

Samples (2 of each) were applied to precut wallboard panels with Sherwin-Williams DURATION® paint and rolled down with 4.5 lb roller. Adhesion build-up on Sherwin-Williams DURATION® paint was measured with 180 degree peel with Q tester.

Sample 3 adhesion build-up reached 43-44 oz/in. This type of adhesion built created difficulties removing the tape from painted wallboard especially when peeled off with medium/high speed (hand peel) as it may damage sheet rock by removing the paint and delaminating the sheetrock facing. However, sample 2 showed lower adhesion on Sherwin-Williams DURATION® paint to start with and did not exceed average of 28 oz/in adhesion after 15 days. Sample 2 had harder PSA coated at the bottom (0.3 oz/yd²) and (0.7 oz/yd²) softer adhesive coated at the top. Sample 1 had softer but cross-linked adhesive coated at the bottom as 0.3 oz/yd² and 0.7 oz/yd² softer PSA coated at the top. Adhesion build on Sherwin-Williams DURATION® paint was still better (lower) than sample 3, which had only 1 pass coating of 1.0 oz/yd² soft adhesive. It was concluded that adhesion build-up is related to the coating weight of PSA and the modulus of the system: softer adhesive system(s) flow more and build-up more adhesion on the described surface.

TABLE 9
Room Temperature testing (70° F., 50% Relative Humidity
(RH))

| | | Sample 1 | Sample 2 | Sample 3 |
|---|---|---|---|---|
| Initial | | 18/23 | 16/17 | 37/28 |
| 1 | day | 26/26 | 16/25 | 38/39 |
| 5 | days | 28/30 | 17/25 | 37/37 |
| 9 | days | 33/33 | 24/25 | 39/41 |
| 12 | days | 33/34 | 26/28 | 40/42 |
| 15 | days | 35/37 | 30/26 | 43/44 |

Measured with MTS Q tester at 12 inches per minute speed at 180° peel.

### Example

### Draw Down

TABLE 10

| Draw Down: | Sample 1 | Sample 2 | Sample 3 |
|---|---|---|---|
| Bottom: AROSET ® 1149-1 | 0.5 oz/yd² | | |
| Bottom; AROSET ® 2505 | | 0.5 oz/yd² | |
| Top: AROSET ® 2505 | 0.5 oz/yd² | 0.5 oz/yd² | 1 oz/yd² |

Paint: Sherwin-Williams DURATION® Paint (Styrenated Acrylic)

TABLE 11

| | Sample 1 | Sample 2 | Sample 3 |
|---|---|---|---|
| Instant | 16 | 21 | 13 |
| 3 days | 20 | 30 | 18 |
| 5 days | 24 | 33 | 26 |
| 7 days | 18 | 33 | 24 |
| 10 days | 14 | 36 | 27 |
| 14 days | 18 | 35 | 23 |

Paint: Sherwin-Williams SUPERPAINT® Paint (Vinyl Acrylic)

TABLE 12

| | Sample 1 | Sample 2 | Sample 3 |
|---|---|---|---|
| Instant | 22 | 26 | 30 |
| 3 days | 37 | 39 | 43 |
| 5 days | 32 | 36 | 46 |
| 7 days | 27 | 40 | 46 |
| 10 days | 31 | 44 | 43 |
| 14 days | 29 | 44 | 42 |

Adhesion Build Up On Olympic Flat (Polyvinyl Acetate)

TABLE 13

| | Ratio of | | | | |
|---|---|---|---|---|---|
| | Layers | | | | |
| Time | (1149B/2505T) | 1 hour | 1 day | 5 days | 11 days |
| Peel Adhesion* | 0.3/0.7 | 16.5 oz/in | 17.03 | 18.93 | 20 |
| to Painted | | | oz/in | oz/in | oz/in |
| Surface | | | | | |
| (Olympic Flat) | | | | | |
| (1149B/2505T) | | | | | |
| Peel Adhesion* | 0.5/0.5 | 22.9 oz/in | 21.6 | 25.1 | 21.9 |
| to Painted | | | oz/in | oz/in | oz/in |
| Surface | | | | | |
| (Olympic Flat) | | | | | |
| (1149B/2505T) | | | | | |
| Peel Adhesion* | 1.00 | 31.4 oz/in | 32.8 | 32.93 | 37.5 |
| to Painted | | | oz/in | oz/in | oz/in |
| Surface | | | | | |
| (Olympic Flat) | | | | | |
| (1 layer 2505) | | | | | |

*Represents average of three samples.

Adhesion Build Up On VALSPAR Flat (100% Acrylic)

TABLE 14

| | Ratio of Layers | | | | | |
|---|---|---|---|---|---|---|
| Time | (1149B/2505T) | 1 hour | 1 day | 5 days | 11 days | 18 days |
| Peel Adhesion* | 0.3/0.7 | 14.4 oz/in | 13.7 oz/in | 15 oz/in | 14.7 oz/in | 17.6 oz/in |
| to Painted | | | | | | |
| Surface (Valspar | | | | | | |
| Flat) | | | | | | |
| (1149B/2505T) | | | | | | |
| Peel Adhesion* | 0.7/0.3 | 18.9 oz/in | 16.93 oz/in | 17.5 oz/in | 17.5 oz/in | 20.5 oz/in |
| to Painted | | | | | | |
| Surface (Valspar | | | | | | |
| Flat) | | | | | | |
| (1149B/2505T) | | | | | | |
| Peel Adhesion* | 1.00 | 23.57 oz/in | 22.3 oz/in | 25.6 oz/in | 24 oz/in | 27.8 oz/in |
| to Painted | | | | | | |
| Surface (Valspar | | | | | | |
| Flat) | | | | | | |
| (2505) | | | | | | |

*Represents average of three samples.

Adhesion Build Up On VALSPAR Flat (100% Acrylic)

TABLE 15

| | Ratio of Layers | | | | | |
|---|---|---|---|---|---|---|
| Time | (2522B/1299T) | 1 hour | 1 day | 5 days | 11 days | 18 days |
| Peel | 0.5/0.5 | 10.83 oz/in | 11.27 oz/in | 11.87 oz/in | 11.83 oz/in | 10.5 oz/in |
| Adhesion* | | | | | | |
| (2522B/1299T) | | | | | | |
| Peel | 0.7/0.3 | 13.7 oz/in | 14.6 oz/in | 14.8 oz/in | 16.7 oz/in | 17.4 oz/in |
| Adhesion* | | | | | | |
| (2522B/1299T) | | | | | | |
| Peel | 1.00 | 19.4 oz/in | 16.83 oz/in | 16.77 oz/in | 18.1 oz/in | 20.2 oz/in |
| Adhesion*(one | | | | | | |
| layer 1299T) | | | | | | |

*Represents average of three samples.

Quick Stick Tests

90 Degree Quick Stick tests were conducted. Tape was gently applied on stainless steel panel. No roll down machine was used to adhere the strip onto steel panel. Tape was pulled from panel with 90 degree angle. It is a measure of tack. PSTC method #5 was followed. The higher the number is tackier the adhesive. Units are oz/inch.

TABLE 16
Physical Test Data

| | | | | 1149 | 2505 |
|---|---|---|---|---|---|
| | Units | 1149B/2505T | | (one layer) | (one layer) |
| | oz/sqyd | 0.3/0.7 | .7/0.3 | 1 | 1 |
| Adhesion to | oz/in | 30 | 30 | 25 | 33 |
| Steel | | | | | |
| Total Wt. | oz/sqyd | 3.11 | 3.2 | 3.21 | 3.25 |
| Adh Wt. | oz/sqyd | 1.02 | 1.05 | 1.1 | 1.1 |
| Rolling Ball | in | 3 | 3 | 2.7 | 3.1 |
| Tack | | | | | |
| 90 Degree QS | oz/in | 16 | 19 | 8.2 | 21 |

| | | |
|---|---|---|
| 2505B/1149T | 1149 | 2505 |

| | | | | | |
|---|---|---|---|---|---|
| | oz/sqyd | 0.3/0.7 | 0.5/0.5 | 1 | 1 |
| Adhesion to | oz/in | 30 | 30 | 25 | 33 |
| Steel | | | | | |
| Total Wt. | oz/sqyd | 2.9 | 2.99 | 3.21 | 3.25 |
| Adh. Wt | oz/sqyd | 0.95 | 1.02 | 1.1 | 1.1 |
| Rolling Ball | in | 3.6 | 2.6 | 2.7 | 3.1 |
| Tack | | | | | |
| 90 degree QS | oz/in | 18 | 19 | 8.2 | 21 |

| | | 2522B/1299T | | 1299 | 2522 |
|---|---|---|---|---|---|
| | oz/sqyd | 0.5/0.5 | 0.7/0.3 | 1 | 1 |
| Adhesion to | oz/in | 22 | 18 | 10 | 0.3 |
| Steel | | | | | |
| Total Wt. | oz/sqyd | 3.19 | 3.08 | 3.09 | 3.19 |
| Adh Wt | oz/sqyd | 1.1 | 1.05 | 1.06 | 1.1 |
| Rolling Ball | in | 4.3 | 4.6 | 5 | 10+ |
| Tack | | | | | |
| 90 Degree QS | oz/in | 10 | 9 | 10 | 0.4 |

### Comparative Example

Adhesion Build Up On VALSPAR Flat (100% Acrylic)

TABLE 17

| | Ratio of Layers | | | | | |
|---|---|---|---|---|---|---|
| Time | (2505B/1149T) | 1 hour | 1 day | 5 days | 11 days | 18 days |
| Peel | 0.3/0.7 | 20.23 oz/in | 22.27 oz/in | 26.1 oz/in | 28.2 oz/in | 27.6 oz/in |
| Adhesion* | | | | | | |
| (2505B/1149T) | | | | | | |
| Peel | 0.5/0.5 | 18.27 oz/in | 21 oz/in | 25.4 oz/in | 25.6 oz/in | 31.1 oz/in |
| Adhesion* | | | | | | |
| (2505B/1149T) | | | | | | |
| Peel | 1.00 | 21.2 oz/in | 18.9 oz/in | 18.57 oz/in | 17.7 oz/in | 19.3 oz/in |
| Adhesion* | | | | | | |
| (1149) | | | | | | |

*Represents average of three samples.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A multilayer adhesive tape comprising:
a substrate, and
at least two layers of a pressure sensitive adhesive applied to the substrate, wherein the at least two layers of adhesive comprise an underlayer of adhesive applied to the substrate and an overlayer of adhesive applied over the underlayer, wherein the underlayer of adhesive has a relatively lower flowability than the overlayer of adhesive and overlayer of adhesive has a relatively greater tackiness than the underlayer of adhesive.

2. The tape according to claim 1, wherein the adhesive of the overlayer is an acrylic pressure sensitive adhesive.

3. The tape according to claim 1, wherein the adhesive of the underlayer is an acrylic pressure sensitive adhesive.

4. The tape according to claim 1, wherein the adhesive of the underlayer and the adhesive of the overlayer are acrylic pressure sensitive adhesives.

5. The tape according to claim 1, wherein the multilayer adhesive tape has a peel adhesion from a painted surface in a range of from about 10 to 25 oz/inch.

6. The tape according to claim 5, wherein the multilayer adhesive tape has a peel adhesion from a painted surface in a range of from about 15 to 22 oz/inch.

7. The tape according to claim 1, wherein the overlayer and underlayer are in a ratio of underlayer to overlayer in a range of about 30:70 to 70:30.

8. A method of making a multilayer adhesive tape, the method comprising;
providing a substrate, and
applying at least two layers of a pressure sensitive adhesive to the substrate,
wherein an underlayer of adhesive is applied to the substrate and an overlayer of adhesive is applied over the underlayer of adhesive, and
wherein the underlayer of adhesive has a relatively lower measurable flowability than the overlayer of adhesive and the overlayer of adhesive has a relatively greater measurable tackiness than the underlayer of adhesive.

9. The method according to claim 8, wherein the adhesive of the overlayer is an acrylic pressure sensitive adhesive.

10. The method according to claim 8, wherein the adhesive of the underlayer is an acrylic pressure sensitive adhesive.

11. The method according to claim 8, wherein the adhesive of the underlayer and the adhesive of the overlayer are acrylic pressure sensitive adhesives.

12. The method according to claim 8, further comprising applying the multilayer adhesive tape to a painted surface.

13. A multilayer adhesive tape comprising:
a substrate, and
at least two layers of a pressure sensitive adhesive applied to the substrate, comprised of
an underlayer of adhesive applied to the substrate and an overlayer of adhesive applied over the underlayer, wherein the adhesive of the underlayer has a higher glass transition temperature than the adhesive of the overlayer.

14. The tape according to claim 13, wherein the adhesive of the overlayer is an acrylic pressure sensitive adhesive.

15. The tape according to claim 13, wherein the adhesive of the underlayer is an acrylic pressure sensitive adhesive.

16. The tape according to claim 13, wherein the adhesive of the underlayer and the adhesive of the overlayer are acrylic pressure sensitive adhesives.

17. The tape according to claim 13, wherein the multilayer adhesive tape has a peel adhesion from a painted surface in a range of from about 10 to 25 oz/inch.

18. The tape according to claim 17, wherein the multilayer adhesive tape has a peel adhesion from a painted surface in a range of from about 15 to 22 oz/inch.

19. A method of making a multilayer adhesive tape, the method comprising;
providing a substrate, and
applying at least two layers of a pressure sensitive adhesive to the substrate, wherein an underlayer of adhesive is applied to the substrate and an overlayer of adhesive is applied over the underlayer and wherein the adhesive of the underlayer has a higher glass transition temperature than the adhesive of the overlayer.

20. The method according to claim 19, wherein the adhesive of the overlayer is an acrylic pressure sensitive adhesive.

21. The method according to claim 19, wherein the adhesive of the underlayer is an acrylic pressure sensitive adhesive.

22. The method according to claim 19, wherein the adhesive of the underlayer and the adhesive of the overlayer are acrylic pressure sensitive adhesives.

23. A painter's tape comprising:
a saturated paper having opposing sides,
at least two layers of acrylic pressure sensitive adhesive applied to a first side of the saturated paper, comprised of
an underlayer of acrylic pressure sensitive adhesive applied to the first side of the saturated paper and an overlayer of acrylic pressure sensitive adhesive applied over the underlayer, wherein the underlayer has a relatively lower flowability than the overlayer and overlayer has a relatively greater tackiness than the underlayer, and
a release coating applied to a second side of the saturated paper.

24. The painter's tape according to claim 23, wherein the saturated paper is a crepe paper.

25. The painter's tape according to claim 23, wherein the saturated paper is a kraft paper.

26. The painter's tape according to claim 23, wherein the paper is saturated with styrene-butadiene rubber (SBR), acrylic, ethylene vinyl acetate, polyurethane, or a combination thereof.

27. The painter's tape according to claim 23, wherein the acrylic pressure sensitive adhesive is water based.

28. A method of making a painters tape, the method comprising;
providing a saturated paper having opposing sides,
applying at least two layers of acrylic pressure sensitive adhesive to a first side of the saturated paper,
wherein an underlayer of adhesive is applied to the first side of the saturated paper and an overlayer of adhesive is applied over the underlayer, and
wherein the underlayer has a relatively lower measurable flowability than the overlayer and the overlayer has a relatively greater measurable tackiness than the underlayer, and
applying a release layer coating to a second side of the saturated paper.

29. The method according to claim 28, wherein the saturated paper is a crepe paper.

30. The method according to claim 28, wherein the saturated paper is a kraft paper.

31. The method according to claim 28, wherein the paper is saturated with styrene-butadiene rubber (SBR), acrylic, ethylene vinyl acetate, polyurethane, or a combination thereof.

32. The method according to claim 28, wherein the acrylic pressure sensitive adhesive is water based.

33. A painter's tape comprising:
a saturated paper having opposing sides,
at least two layers of acrylic pressure sensitive adhesive applied to a first side of the saturated paper, wherein an underlayer of adhesive is applied to the substrate and an overlayer of adhesive is applied over the underlayer and wherein the adhesive of the underlayer has a higher glass transition temperature than the adhesive of the overlayer, and
a release coating applied to a second side of the saturated paper.

34. The painter's tape according to claim 33, wherein the saturated paper is a crepe paper.

35. The painter's tape according to claim 33, wherein the saturated paper is a kraft paper.

36. The painter's tape according to claim 33, wherein the paper is saturated with styrene-butadiene rubber (SBR), acrylic, ethylene vinyl acetate, polyurethane, or a combination thereof.

37. The painter's tape according to claim 33 wherein the acrylic pressure sensitive adhesive is water based.
